(19) United States
(12) Patent Application Publication
(10) Pub. No.: US 2026/0036132 A1
(43) Pub. Date: Feb. 5, 2026

(54) Centrifugal Pump Having Wear-Resistant Wear Plate With Scraper Element

(71) Applicant: KSB SE & Co. KGaA, Frankenthal (DE)

(72) Inventors: Enrico MUELLER, Frankenthal (DE); Daniel ZIEGS, Frankenthal (DE)

(21) Appl. No.: 18/698,236

(22) PCT Filed: Sep. 23, 2022
(86) PCT No.: PCT/EP2022/076513

§ 371 Date: Jun. 12, 2025

(30) Foreign Application Priority Data
Oct. 4, 2021 (DE) 10 2021 125 642.9
Sep. 22, 2022 (DE) 10 2022 124 356.7

(51) Int. Cl. F04D 29/22; F04D 7/04; F04D 29/02

(52) U.S. Cl. CPC F04D 29/2294; F04D 7/04; F04D 29/026

(57) ABSTRACT

A centrifugal pump is configured to convey media containing solids. The centrifugal pump includes an open impeller. The open impeller has at least one blade and a mating element interacting therewith. The mating element includes an element which protrudes into a suction eye of the centrifugal pump and interacts with a leading edge of the at least one blade of the open impeller. The mating element is configured in two parts, a first part and a second part. The two parts are configured to render the element elastic.

### CROSS REFERENCE TO RELATED APPLICATIONS

This application is a 371 National Stage Application of PCT/EP2022/076513, filed Nov. 23, 2022, which claims priority from German Patent Application No. 102021125642.9 filed Oct. 4, 2021 and 102022124356.7 filed Sep. 22, 2022, the entire disclosures of which are herein expressly incorporated by reference.

### BACKGROUND

Centrifugal pump for conveying media containing solids, having an open impeller having at least one blade and a mating element interacting therewith, wherein the mating element comprises an element which protrudes into the suction eye of the centrifugal pump and interacts with a leading edge of the at least one blade of the open impeller.

Waste water can contain various types of solids and fibrous materials, the quantity and structure thereof possibly being dependent on the waste water source as well as the season. For example, plastics materials, sanitary items, textiles, etc., are usual in urban areas, while wear particles can be contained in industrial zones.

Different impellers, for example inducers, free-flow wheels or single-blade wheels, can be used in centrifugal pumps for conveying media containing solids. An open impeller interacts with a so-called wear plate in the pump chamber, said wear plate being fixed in the pump housing.

In general, castings are often used in centrifugal pumps. A solid member in the desired shape is derived after solidification when casting from a liquid material. In this way, the desired housing structures, wear plates, or impellers, of the centrifugal pump can be generated in a targeted manner. In the construction of centrifugal pumps, cast materials are typically iron-carbon alloys. In centrifugal pumps for conveying media containing solids, wear plates made by gravity die-casting, which to some extent may have ceramic reinforcements, have typically proven successful.

Described in DE 43 26 545 C2 is wear plate based on ceramics, in particular based on silicon carbide, which is produced by means of a slip casting process. This wear plate is embedded into the housing of a centrifugal pump in a form-fitting manner and sealed with a rubber coating on the housing wall.

Described in DE 10 2013 200 680 B4 is a method for generating a wear plate. The wear-resistant layer herein is incorporated as a preform into a casting tool and then cast using a casting material, preferably using a metallic casting material.

DE 10 2017 223 602 A1 discloses a pump housing in which, instead of wear plates, ceramic wear-resistant plates, which are already adhesively bonded to a metallic casting material in the casting tool prior to casting, are disposed in the pump housing. These wear-resistant plates are preferably made of silicon carbide.

As evidenced by experience, the major issues in waste water pumps are created by fibrous material such as rags, cloths and the like, which settle on the leading edges of the blades and can wrap themselves about the impeller hub. Such incidents lead to frequent maintenance operations and to a reduced efficiency of the pump.

There are already various approaches to solving this issue, which utilize cutting tools or else scraping tools in order to be able to remove the contaminants settled on the leading edges during operation of the pump.

WO 2020/127782 discloses a centrifugal pump having a stationary scraper which scrapes along the blade edge of an impeller in order to release deposits. As a result of the scraping contact, such a construction is subjected to high mechanical stress.

WO 2021/028246 describes a waste water pump for conveying waste water loaded with solids, having a spiral housing with an inlet opening, an impeller with at least one blade, wherein the leading edge assigned to the respective blade runs from the impeller hub rearward in a curved manner to the outside, and at least one finger for scraping contamination from the leading edge, wherein the finger is disposed on the inner wall of the inlet and extends in the direction of the rotation axis R of the impeller, and wherein at least one groove is provided so as to be incorporated in a suction-side inner wall of the housing, and the leading edge of the impeller and the upper finger face that faces the leading edge have an angle α of 5° to 75° in relation to the perpendicular projection surface of the rotation axis R.

### SUMMARY

It has proven disadvantageous herein that the finger for scraping can suffer fracture-like damage during abrupt contact or under a shock-like load if the finger for scraping is formed from a hard and brittle material in order to provide protection against abrasion.

It is an object of the disclosure to specify a centrifugal pump for conveying media containing solids, which offers effective protection in relation to deposits and accumulations. Damage to the centrifugal pump due to shock-like loads and due to abrasive wear is to be prevented. Moreover, the pump is intended to be able to maintain efficiency for a long time during operation. The centrifugal pump is intended to be distinguished by a high degree of reliability and great durability. It is also intended to ensure simple assembly and good adjustment options. Moreover, said centrifugal pump is to be a compelling proposal thanks to ideally low production costs.

This object is achieved according to the disclosure by a centrifugal pump for conveying media containing solids. Preferred variants can be derived from the dependent claims, the description and the drawings.

According to the disclosure, the mating element is configured in two parts, having a first part and a second part, for the elastic design of the element. Additionally, the element is configured to be shock-resistant so as to be able to withstand loads when conveying media containing solids.

In a particularly advantageous variant, the mating element is embodied as a wear plate which is configured in two parts for fulfilling the task set. The wear plate interacts with an open impeller for conveying media containing solids, wherein the impeller preferably has two or three blades. In an alternative variant, the impeller can also be embodied as a single-blade impeller, or comprise four to five blades. The element herein is embodied as a device for scraping blockages, entanglements and fibrous deposits, and for this purpose interacts with the open impeller, in particular the leading edges, and optionally with the impeller hub.

In a particularly favorable variant of the disclosure, the element extends from the inner wall of the inlet of the mating element radially inward in the direction of the rotation axis of the impeller. An upper element face, which faces the leading edge, runs at a defined spacing from the leading edge and so as to be substantially parallel to the leading edge in such a way that the desired scraping effect results from the upper element face which faces the leading edge, or from the lateral engagement face of the element, respectively, without permanently mechanically stressing the mating element and the element per se. The interaction between the rearwardly curved leading edge of the mating element and of the element per se facilitates the removal of solids established on the impeller leading edge.

The element is preferably configured to be integral to the second part of the mating element. This results in an advantageous shape and in an effective inlet of the medium with solids, which does not offer any engagement faces for abrasion or any surfaces for deposits.

Hardness testing of cast materials is preferably determined by the Brinell hardness (HB) according to ISO 6506 and ASTM E10. In the process, a hard metal ball is pressed into the surface of the workpiece to be tested using an established testing force F. The standard prescribes balls made of sintered hard metal, for example tungsten-carbide hard metal, for all materials. The balls used have diameters of 10 mm, 5 mm, 2.5 mm and 1 mm.

The thickness of the specimen is chosen in such a way that no deformation is visible on the lower side after testing. This is the case as from a thickness of eight to ten times the depth of the impression. The testing load is chosen in such a way that 0.24 D<d<0.6 D. The spacing between the center of the impression and the periphery of the specimen should be more than 3 d, while the spacing between two impressions should be more than 6 d. The testing force is applied orthogonally to the test surface in an shock-free and vibration-free manner, and is increased within 5 to 8 seconds. For steel and cast iron, the diameter of the lasting impression in the workpiece is measured after a time of constant load of 10 to 15 seconds, and the surface of the impression is determined therefrom. The Brinell hardness is defined as the ratio of testing force to impression surface.

In order to guarantee a high abrasion resistance of the centrifugal pump for conveying media containing solids, the first part of the mating element has a greater hardness than the second part. The hardness of the first part according to Brinell is preferably more than 550 HB, preferably more than 600 HB, in particular more than 650 HB.

The elongation at break is an indicator of materials that indicates the lasting elongation of the tensile specimen after breakage in terms of the initial length measured. Said elongation at break characterizes the deformation capability, or the ductility, of a material, respectively.

For the avoidance of damage by shock-like loads, the second part of the mating element, which is embodied so as to be integral to the element, and the element per se are designed to be more ductile than the first part of the mating element. The elongation at break as a measure of the ductility of the second part is more than 14%, preferably more than 16%, in particular more than 18%.

Ductile materials such as steel elongate even further once exceeding the tensile strength during tensile testing, whereby the specimen bar is constricted. Brittle materials such as cast iron, on the other hand, break almost without constriction. The tensile strength of the second part of the mating element is more than 400 N/mm², preferably more than 500 N/mm², in particular more than 600 N/mm², for the elastic design of the element.

The notch impact strength is a measure for the resistance of a material in relation to impact-type and dynamic stress. The notch impact strength of the second part of the mating element including the element per se is more than 10 N/cm², preferably more than 12 N/cm², in particular more than 14 N/cm². As a result of the advantageous design embodiment of the second part of the mating element, the latter is effectively protected against destruction by shock-like loads.

In an extremely advantageous variant of the disclosure, the second part of the mating element with the integrally molded element is formed from a spheroidal casting, preferably from EN-GJS-400-18-LT.

In a particularly favorable variant of the disclosure, the first part of the mating element is formed from a gravity die-casting, for example EN-GJN-HB555 (XCr14).

The advantageous design embodiment of the mating element in two parts with different properties achieves a wear plate which is designed to be particularly hard in terms of abrasive wear, and simultaneously a scraper element which is embodied to be particularly elastic in terms of shock-like loads.

Both parts of the mating element ideally form a unit as a complete functional component. For this purpose, the first and the second part of the mating element are preferably connected to one another in a form-fitting manner in the radial direction. When viewed in the flow direction, the second part of the mating element is disposed in front of the first part. The second part of the mating element advantageously forms the suction eye of the centrifugal pump.

In a favorable variant, the parts are joined to one another by an interference fit. The connection can additionally be enhanced by means of a threaded connection in such a way that both parts are connected to one another in a force-fitting manner in the circumferential direction, whereby, for example, six screws are disposed so as to be offset by 60° from one another.

Moreover, a sharp edge in the pump chamber is advantageous for effectively avoiding permanent entanglements. For this purpose, the mating element has a groove, wherein the groove extends tangentially in an encircling manner from the first part to the second part of the mating element and has an offset between the parts. The groove comprises a permanently sharp cutting edge, whereby the offset between the parts of the mating element preferably forms an additional cutting edge.

The mating element preferably comprises at least one tension and/or compression screw for aligning the mating element. In a favorable variant, the mating element formed as a wear plate is aligned in the pump housing using at least four, preferably six, in particular eight, adjustment screws, so that a precisely defined gap is formed between the open impeller and the wear plate.

In a particularly favorable variant, the parts of the mating element are designed to be substantially annular and/or trumpet funnel-like. The shape herein advantageously fits into the pump housing and corresponds symbiotically to the open impeller.

The element ideally extends in the shape of a trihedral pyramid with curved lateral faces, so as to be partially parallel to the mating element, and in the direction of the rotation axis of the impeller, for scraping deposits and fibrous solids. The deposited solids are supplied to the groove with the aid of the element, and entrained by the rotating movement of the impeller in such a way that said fibrous solids, by way of the groove, make their way directly into the region of the housing outlet side. The impeller and the element are specially adapted to one another for this task.

The two-part mating element is preferably made of a metallic material, in particular from castings having the different properties described, so that the first part of the mating element is designed to be particularly hard and robust in terms of abrasive influences, and the second part with the element is designed to be particularly elastic in terms of shock-like loads.

In an alternative variant of the disclosure, the two-part mating element can be formed by additive manufacturing. The term additive manufacturing comprises all manufacturing methods in which material is applied layer-by-layer, thus generating three-dimensional components, in particular two-part wear plates. The layered construction herein is performed in a computer-controlled manner from one or a plurality of liquid or solid materials according to defined dimensions and shapes. Physical or chemical hardening or melting processes take place during construction. Typical materials for 3D printing include plastics materials, metals, carbon and graphite materials.

A particularly favorable form of additive manufacturing is selective laser melting. In selective laser melting, the metallic construction material is applied in the form of a powder in a thin layer on a plate. The pulverulent material is completely fused locally at the respective desired locations by means of radiation, and after solidification forms a firm material layer. This base plate is subsequently lowered by the amount of a layer thickness, and powder is applied again. This cycle is repeated until all layers have been fused. The finished parts of the wear plate have the excess powder cleaned off. In order to achieve the desired properties of the respective part of the wear plate, the respective matching material can be used in the form of a powder.

For example, a laser beam which generates the parts of the wear plate from the individual powder layers can be used for radiation. The data for guiding the laser beam are generated by means of a software, based on a 3D CAD body. An electronic beam (EBM) can also be used as an alternative to selective laser melting.

The centrifugal pump for conveying media containing solids can be operated dry as well as immersed in the conveyed medium, and in any orientation.

Further features and advantages of the disclosure are derived from the description of exemplary embodiments by means of the drawings, and from the drawings per se.

### BRIEF DESCRIPTION OF THE DRAWINGS

In the drawings:

FIG. 1 shows a perspective view of the centrifugal pump according to the disclosure, with an opened pump housing;

FIG. 2 shows a vertical section through the centrifugal pump;

FIG. 3 shows a section through the open impeller and the corresponding mating element;

FIG. 4 shows a perspective illustration of the mating element; and

FIG. 5 shows a further perspective illustration of the mating element.

### DETAILED DESCRIPTION

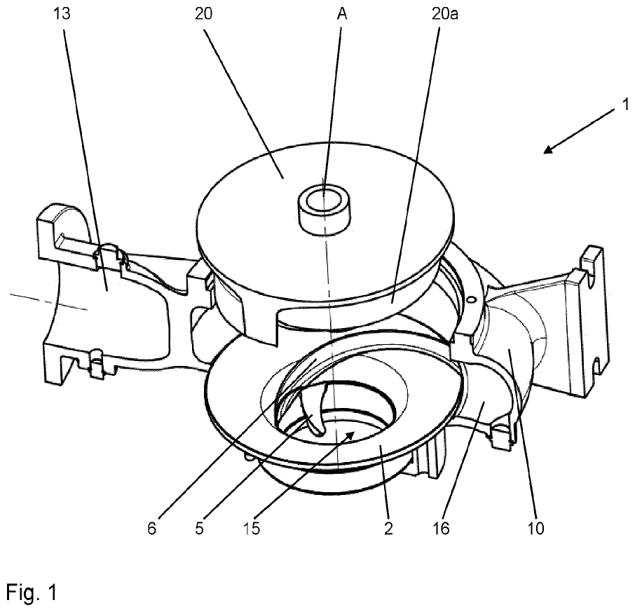

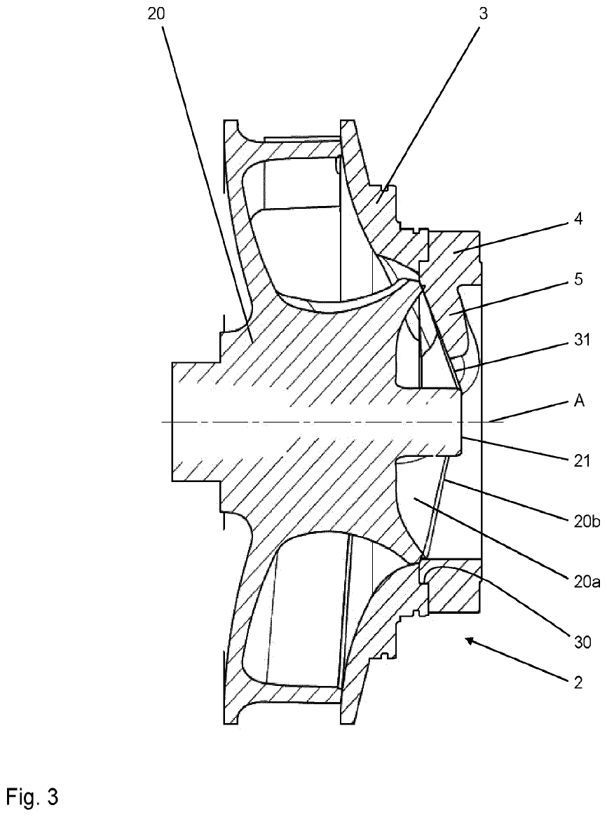

FIG. 1 shows an exploded illustration of the centrifugal pump 1 according to the disclosure. The latter comprises a spiral housing 10, a suction-side mating element 2 in the form of a wear plate, and an impeller 20 rotating about a rotation axis A. The impeller 20 comprises two blades 20a which are curved rearward and by which the conveyed medium is suctioned by way of a cylindrical inlet opening 15 of the mating element 2, conveyed to the outlet side 13 by way of the conveying chamber 16 of the spiral housing 10, and is delivered by way of said outlet side 13. In other embodiments, the impeller 20 may also comprise fewer or more than two blades 20a. The blade or the blades 20a, respectively, have in each case one leading edge 20b which faces the mating element 2 and thus the fluid flow, as is shown in FIG. 3.

The wastewater to be conveyed can be mixed with a multiplicity of different solids, for example fibrous materials which can establish themselves on certain parts of the pump during the operation of the pump. For this reason, an element 5 which is integrally molded on the cylindrical inner wall of the mating element 2 and extends in the direction of the rotation axis A is provided.

The element 5 scrapes away solids which are contained in the conveyed medium and adhere to the impeller 20, in particular to the leading edges 20b of the blades 20a. The solids which have been scraped away can be supplied to the outlet side by way of a spiral groove 6 within the mating element 2, which is specially provided for this purpose.

In order to design the scraping effect of the element 5 in an optimal manner, the shape and position of said element 5 within the mating element 2 has to be adapted to the specific construction of the impeller and the housing. The length of the element 2 should be at least 30%, preferably at least 50%, or at best approximately 70% to 80%, of the radius of the cylindrical mating element 2.

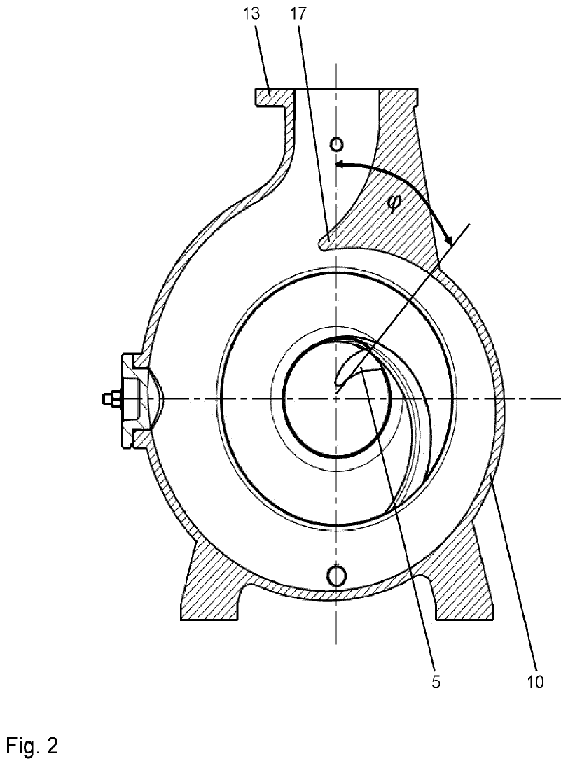

FIG. 2 shows a vertical section through a centrifugal pump 1 which is installed horizontally. The relative position of the element 5 in relation to the spur 17 of the spiral housing 10 can influence the delivery of the scraped-off solids to the outlet side 13. The element 5 is favorably disposed so as to be offset from the spur 17 by the angle φ. The element 5, when viewed in the flow direction, is disposed in front of the spur 17. Solids such as rocks can potentially accumulate in the lower part of the spiral housing 10, or of the impeller 20, respectively. By disposing the element 5 in the environment of the spur 17, said element 5 is positioned outside accumulations of rocks. The angle φ is preferably between 0° and 45°; the angle φ in the variant of embodiment illustrated is 25°.

FIG. 3 shows a section through the open impeller 20 and the mating element 2 which interacts with the leading edge 20b of the at least one blade 20a of the impeller 20. In order for the flow in the pump inlet toward the impeller 20 to be influenced as little as possible by the element 5, the element 5 is shaped in the manner of a pyramid with a total of three, partially rounded lateral faces, and the base area almost bearing on the blade edge 20b of the impeller 20.

The spacing 31 between the blade edge 20b of the impeller 20 and the face of the scraping edge of the element 5 should be in a range between 0.05 mm and 3 mm, whereby this spacing can vary in the radial direction. An excessively large spacing has the risk that small solids cannot be caught by the element 5, whereas an excessively small spacing increases the risk of a collision between the element 5 and the impeller 20.

According to the disclosure, the mating element 2 is embodied in two parts, having a first part 3 and a second part 4. In the variant of embodiment illustrated, the element 5 is designed to be integral to the second part 4. Integral means that this is a component made of one material, the second part 4 and the element 5 thus have the same properties.

In this variant of embodiment of the disclosure, the hardness of the first part 3 according to Brinell is more than 550 HB. For the avoidance of damage by shock-like loads, the second part 4 of the mating element 2 with the element 5 is designed to be more ductile than the first part 3 of the mating element 2. The elongation at break as a measure of the ductility of the second part 4 and of the element 5 here is 18%. The tensile strength of the second part 4 for the elastic design of the element 5 is 400 N/mm², and the notch impact strength is 14 N/cm². As a result of the advantageous design embodiment of the second part 4 of the mating element 2, the latter is effectively protected against destruction by shock-like loads.

In the variant of embodiment of the disclosure illustrated, the second part 4 of the mating element 2 with the integrally formed element 5 has been formed from the material EN-GJS-400-18-LT by means of a casting process, whereby the first part 1 of the mating element 2 has been cast from the material EN-GJN-HB555 (XCr14).

Both parts 3, 4 of the mating element 2 form a unit as a complete functional component. For this purpose, the parts 3, 4 are connected to one another in a form-fitting as well as force-fitting manner, and joined to one another by means of an interference fit 30. The second part 4 of the mating element 2 here substantially forms the suction eye of the centrifugal pump 1.

The advantageous design embodiment of the mating element 2 in two parts 3, 4 with different properties achieves a wear plate which is designed to be particularly hard in terms of abrasive wear, and simultaneously a scraper element which is embodied to be particularly elastic and simultaneously shock-resistant in terms of shock-like loads.

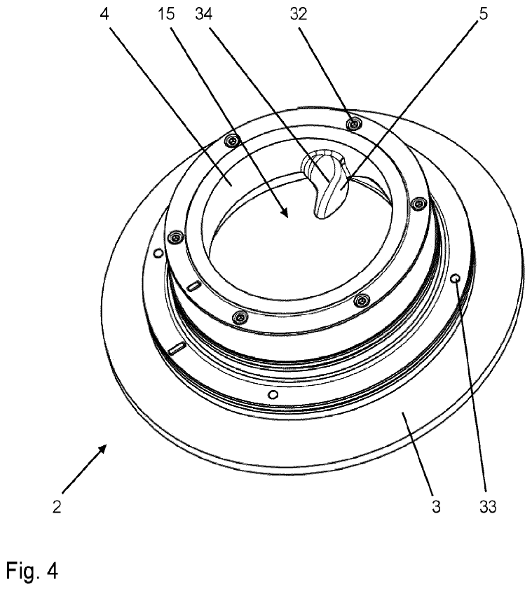

FIG. 4 shows a perspective illustration of the mating element 2 which is fixed so as to form a component from the first part 3 and the second part 4 by means of six screws 32 that are mutually disposed at an angle of in each case 60°. The element 5 protrudes into the inlet opening 15 and has a sharp edge 34 for fragmenting fibrous solids. The mating element 2, in particular the first part 3, has four bores 33 and is fastened to or in the pump housing by means of the bores 33, and adjusted in such a manner that a precise gap is formed between the impeller 20 and the mating element 2. The gap herein is 0.3 mm. It can furthermore be seen that the second element 4, when viewed in the flow direction, is disposed in front of the first element 3.

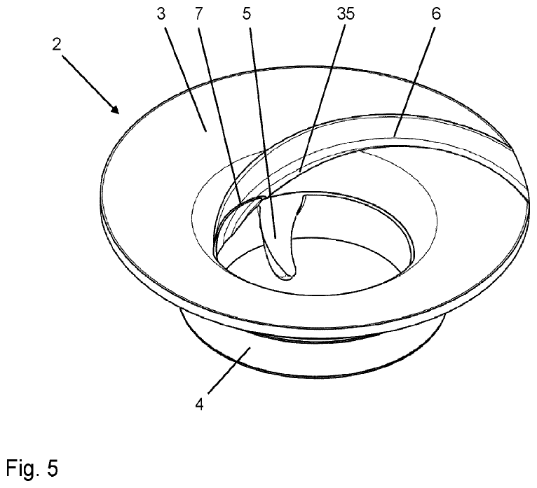

FIG. 5 shows a further, perspective illustration of the mating element 2. For the effective avoidance of permanent entanglements, the mating element 2 has a groove 6, whereby the groove 6 extends tangentially in an encircling manner from the first part 3 to the second part 4 of the mating element 2 and has an offset 7 between the parts 3, 4. The groove 6 comprises a permanently sharp cutting edge 35, whereby the offset 7 between the parts 3, 4 of the mating element 2 forms an additional cutting edge. Moreover, the element 5 in the second part 4 is disposed directly on the groove 6 so that the scraped-off solids can be discharged by way of the groove 6.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-13. (canceled)

14. A centrifugal pump configured to convey media containing solids, the centrifugal pump comprising:
an open impeller having at least one blade and a mating element interacting therewith, wherein
the mating element comprises an element which protrudes into a suction eye of the centrifugal pump and interacts with a leading edge of the at least one blade of the open impeller, and
the mating element is configured in two parts, a first part and a second part, the two parts being configured to render the element elastic.

15. The centrifugal pump as claimed in claim 14, wherein the element is configured to be integral to the second part of the mating element.

16. The centrifugal pump as claimed in claim 15, wherein the first part of the mating element has a greater hardness than the second part, and the hardness of the first part according to Brinell is more than 550 HB.

17. The centrifugal pump as claimed in claim 15, wherein the first part of the mating element has a greater hardness than the second part, and the hardness of the first part according to Brinell is more than 600 HB.

18. The centrifugal pump as claimed in claim 15, wherein the first part of the mating element has a greater hardness than the second part, and the hardness of the first part according to Brinell is more than 650 HB.

19. The centrifugal pump as claimed in claim 16, wherein the second part of the mating element is designed to be more ductile than the first part, and the elongation at break of the second part is more than 14.

20. The centrifugal pump as claimed in claim 19, wherein a tensile strength of the second part is more than 400 N/mm².

21. The centrifugal pump as claimed in claim 20, wherein the first part and the second part of the mating element are connected to one another in a form-fitting and/or force-fitting manner.

22. The centrifugal pump as claimed in claim 21, wherein the mating element has a groove, and the groove extends from the first part to the second part and has an offset between the first and second parts.

23. The centrifugal pump as claimed in claim 20, wherein the mating element comprises at least one tension and/or compression screw configured to align the mating element.

24. The centrifugal pump as claimed in claim 23, wherein the first and second parts of the mating element are configured to be annular and/or trumpet funnel-like.

25. The centrifugal pump as claimed in claim 22, wherein the element has a shape of a trihedral pyramid with curved lateral faces, and extends in a direction of a rotation axis of the impeller.

26. The centrifugal pump as claimed in claim 25, wherein the mating element is formed from a metallic material, including a cast material or a non-corroding steel material.

27. The centrifugal pump as claimed in claim 25, wherein the mating element is formed by additive manufacturing.

28. The centrifugal pump as claimed in claim 27, wherein the mating element is designed as a wear plate.
